(19) United States
(12) Patent Application Publication
(10) Pub. No.: US 2007/0242231 A1
(43) Pub. Date: Oct. 18, 2007

(54) ILLUMINATION SYSTEM AND PROJECTION APPARATUS

(75) Inventors: Sung-Nan Chen, Hsinchu (TW); Keng-Han Chuang, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/627,023

(22) Filed: Jan. 25, 2007

(30) Foreign Application Priority Data
Apr. 17, 2006 (TW) 95113601

(51) Int. Cl. G03B 21/26

(52) U.S. Cl. 353/34

(57) ABSTRACT

An illumination system including a light integration rod, light source modules and a light guide element is provided. The light integration rod has a light incident end and a light exit end. The light source modules are disposed adjacent to the light incident end, and each light source module is suitable for providing a converging light beam. The light guide element is disposed adjacent to the light incident end and between the light source modules for guiding each light beam to be incident to the light integration rod. The optical axes of the light beams are parallel to each other and a distance exists between any two optical axes of the light beams. The light beams are combined inside the light integration rod and emitted from the light exit end to provide an illumination beam. Moreover, a projection apparatus having the illumination system is provided.

### CROSS-REFERENCE TO RELATED APPLICATION

This application claims the priority benefit of Taiwan application serial no. 95113601, filed Apr. 17, 2006. All disclosure of the Taiwan application is incorporated herein by reference.

### BACKGROUND OF THE INVENTION

1. Field of the Invention

The present invention relates to an illumination system and a projection apparatus. More particularly, the present invention relates to an illumination system capable of providing an illumination beam with high brightness and having a preferable heat dissipation effect and a projection system having the illumination system.

2. Description of the Related Art

Referring to FIG. 1, a conventional illumination system 100 is applied to a projection apparatus to provide an illumination beam required by the projection apparatus. The illumination system 100 comprises a blue light emitting diode chip (LED chip) 110, a red LED chip 120, a green LED chip 130, two dichroic mirrors 140 and 150, a condensing lens 160, a light integration rod 170, and three heat sinks 180. The dichroic mirror 140 is suitable for allowing a blue light 112 emitted by the blue LED chip 110 to penetrate, and reflecting a red light 122 emitted by the red LED chip 120. The dichroic mirror 150 is suitable for allowing the blue light 112 and the red light 122 to penetrate, and reflecting a green light 132 emitted by the green LED chip 130. Moreover, the condensing lens 160 is used for converging the blue light 112, the red light 122, and the green light 132, and the light integration rod 170 is suitable for uniformizing the blue light 112, the red light 122, and the green light 132. The heat sinks 180 are respectively connected to the LED chips 110, 120, and 130 to dissipate heat from the LED chips 110, 120, and 130.

In the conventional projection apparatus, the blue LED chip 110, the red LED chip 120, and the green LED chip 130 alternately emit lights, such that blue, red, and green images are sequentially projected on a screen, and color images are obtained by overlapping the images of the three colors. However, as the brightness of a single LED chip is low, the brightness of the images projected on the screen by the projection apparatus is not sufficient.

Referring to FIG. 2, in order to solve the problem of the insufficient brightness of the illumination beam provided by the illumination system 100, the illumination system 200 utilizes LED arrays to enhance the brightness of the illumination beam. In detail, the illumination system 200 comprises a blue LED array 210, a red LED array 220, a green LED array 230, two dichroic mirrors 240, 250, and a light integration rod 260. The blue LED array 210 comprises a plurality of blue LED chips 212, the red LED array 220 comprises a plurality of red LED chips 222, and the green LED array 220 comprises a plurality of green LED chips 232. The dichroic mirror 240 is suitable for allowing red light 223 emitted by the red LED chips 222 and green light 233 emitted by the green LED chips 232 to penetrate, and reflecting blue light 213 emitted by the blue LED chips 212. The dichroic mirror 250 is suitable for allowing the red light 223 and the blue light 213 to penetrate, and reflecting the green light 233.

In the illumination system 200 described above, since each of the LED arrays 220, 230, 240 is adjacent to the light incident end 262 of the light integration rod 260, and the LED chips of each of the LED arrays 220, 230, 240 are arranged compactly, the heat dissipation is quite difficult. In order to improve the heat dissipation, expensive heat sinks of complicated structures are required to dissipate heat from the LED arrays 220, 230, and 240, thus significantly increasing the cost of the heat sinks. Moreover, the illumination system 200 lacks condensing elements to converge light provided by each of the LED arrays 220, 230, and 240, so the light incident to the light integration rod 260 is a diverging light, resulting in a poor light use efficiency of the illumination beam provided by the illumination system 200.

### SUMMARY OF THE INVENTION

An objective of the present invention is to provide an illumination system for providing an illumination beam with high brightness and saving the cost of heat radiating elements.

Another objective of the present invention is to provide a projection apparatus, in which the illumination system thereof provides an illumination beam with high brightness and has a preferable heat dissipation effect.

In order to achieve the aforementioned or one or more objectives, the present invention provides an illumination system, which comprises a light integration rod, a plurality of light source modules, and a light guide element. The light integration rod has a light incident end and a light exit end opposite to the light incident end. The light source modules are disposed adjacent to the light incident end of the light integration rod, and each of the light source modules is suitable for providing a converging light beam. The light guide element is disposed adjacent to the light incident end of the light integration rod and between the light source modules for guiding each of the light beams to be incident to the light integration rod from the light incident end. The optical axes of the light beams are parallel to each other and a distance exists between any two optical axes of the light beams. The light beams are combined inside the light integration rod and emitted from the light exit end to provide an illumination beam.

The present invention also provides a projection apparatus, which comprises a light valve, a projection lens, and the above illumination system. The light valve is disposed on the transmission path of the illumination beam provided by the illumination system, so as to convert the illumination beam into an image beam. The projection lens is disposed on the transmission path of the image beam.

The illumination beam provided by the illumination system according to the present invention converges the light beams provided by the plurality of light source modules, so the illumination beam has high brightness. Furthermore, as the light source modules are scattered, each of the light source module is easy to dissipate heat, and expensive heat sinks with complicated structures are not required. Therefore, the projection apparatus using the illumination system not only projects images with high brightness, but also saves the cost of heat sink elements.

Other objectives, features and advantages of the present invention will be further understood from the further technology features disclosed by the present invention wherein there are shown and described preferred embodiments of this invention, simply by way of illustration of modes best suited to carry out the invention.

### BRIEF DESCRIPTION OF THE DRAWINGS

FIG. 1 is a schematic view of a conventional illumination system.

FIG. 2 is a schematic view of another conventional illumination system.

FIG. 3 is a schematic view of an illumination system according to an embodiment of the present invention.

FIG. 4A is a front view of a light incident end of a light integration rod in FIG. 3.

FIG. 4B is a front view of a light incident end of a light integration rod according to another embodiment of the present invention.

FIGS. 5A to 5C are schematic views of a first color light source, a second color light source, and a third color light source of an illumination system according to yet another embodiment of the present invention respectively.

FIG. 6 is a schematic view of an illumination system according to yet another embodiment of the present invention.

FIG. 7 is a schematic view of a projection apparatus according to an embodiment of the present invention.

### DESCRIPTION OF THE PREFERRED EMBODIMENTS

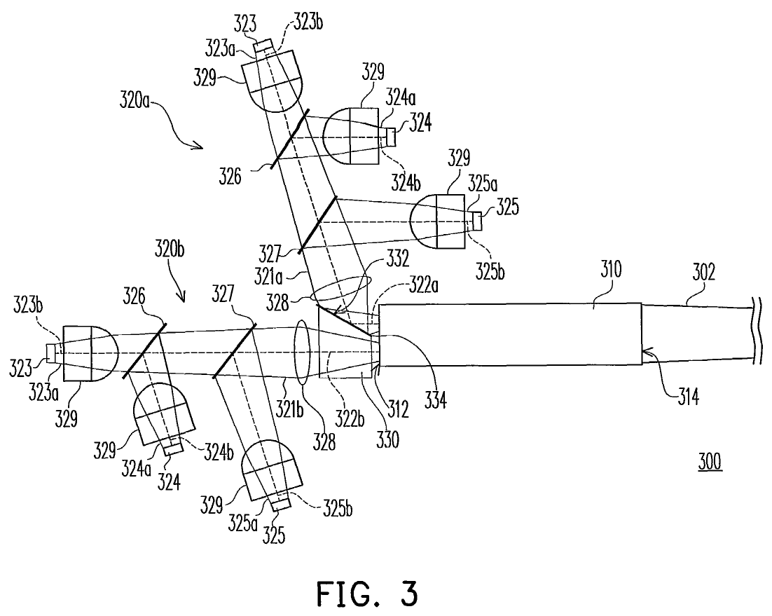

Referring to FIG. 3, an illumination system 300 of the embodiment is applied to a projection apparatus to provide an illumination beam. The illumination system 300 comprises a light integration rod 310 and two light source modules 320a, 320b. The light integration rod 310a has a light incident end 312 and a light exit end 314 opposite to the light incident end 312. The light source modules 320a and 320b are disposed adjacent to the light incident end 312 of the light integration rod 310. The light source module 320a is suitable for providing a light beam 321a, and the light source module 320b is suitable for providing a light beam 321b. The light beams 321a and 321b are gradually converged and incident to the light integration rod 310 from the light incident end 312. When the light beams are transmitted to the light incident end 312, the optical axes 322a, 322b of the light beams 321a, 321b are respectively parallel to each other. Furthermore, the light beams 321a and 321b are combined within the light integration rod 310 and emitted from the light exit end 314 to provide an illumination beam 302.

In the embodiment, each of the light source modules 320a and 320b has a first color light source 323, a second color light source 324, a third color light source 325, a first dichroic element 326 disposed between the first color light source 323 and the second color light source 324, a second dichroic element 327 dispersed between the third color light source 325 and the first dichroic element 326, and a condensing element 328. The first color light source 323 is suitable for providing a first color light beam 323a, the second color light source 324 is suitable for providing a second color light beam 324a, and the third color light source 325 is suitable for providing a third color light beam 325a. In addition, the first dichroic element 326a, such as a dichroic mirror, is suitable for allowing the first color light beam 323a to penetrate, and reflecting the second color light beam 324a. The optical axis 323b of the first color light beam 323a after penetrating the first dichroic element 326 is the same as the optical axis 324b of the second color light beam 324a after being reflected by the first dichroic element 326. The second dichroic element 327 is a dichroic mirror, which is suitable for allowing the first color light beam 323a and the second color light beam 324a to penetrate, and reflecting the third color light beam 325a. The optical axes 323b, 324b of the first color light beam 323a and the second color light beam 324a after penetrating the second dichroic element 327 are the same as the optical axis 325b of the third color light beam 325a after being reflected by the second dichroic element 327.

The first color light source 323, the second color light source 324, and the third color light source 325 described above are, for example, one of a red light source, a blue light source, and a green light source respectively. The first color light source 323, the second color light source 324, and the third color light source 325 of each of the light source modules 320a and 320b is, for example, an LED chip. As color images projected on a screen by a common projection apparatus are obtained by overlapping red, blue, and green images, in the illumination system 200, the first color light source 323, the second color light source 324, and the third color light source 325 alternately emit light beams, such that the projection apparatus sequentially generates images of different colors. Moreover, in order to enhance the brightness of the images, the first color light source 323, the second color light source 324, and the third color light source 325 also emits light beams simultaneously. Therefore, the light beams 321a, 321b provided by the light source modules 320a, 320b are the first color light beam 323a, the second color light beam 324a, the third color light beam 325a or any combination thereof.

Accordingly, the condensing element 328 is, for example, a condensing lens, which is disposed on the transmission paths of the first color light beam 323a, the second color light beam 324a, and the third color light beam 325a, so as to converge the light beams. In addition, a light guide element is disposed in front of the light incident end 312 of the light integration rod 310 and between the light source modules 320a, 320b. In this embodiment, the light guide element is a prism 330. The prism 330 has a reflecting surface 332, which is suitable for reflecting the light beam 321a to the light integration rod 310. The light beam 321b penetrates the prism 330 and then is incident to the light integration rod 310, and the optical axis 322a of the light beam 321a after being reflected by the reflecting surface 332 is parallel to the optical axis 322b of the light beam 321b, and a distance exists between the two optical axes. The reflecting surface 332 of the prism 330 is, for example, the surface of a coating layer 334 disposed on the prism 330, and the material of the coating layer 334 is silver or other suitable metal materials.

It should be noted that the aforementioned light guide element is also replaced by a reflecting mirror (not shown), which is disposed at a position corresponding to the position of the reflecting surface 332 of the prism 330. Moreover, a lens 329 is disposed in front of the light exit end of each of the first color light source 323, the second color light source 324, and the third color light source 325, so as to adjust the exit light shape of the first color light beam 323a, the second color light beam 324a, and the third color light beam 325a.

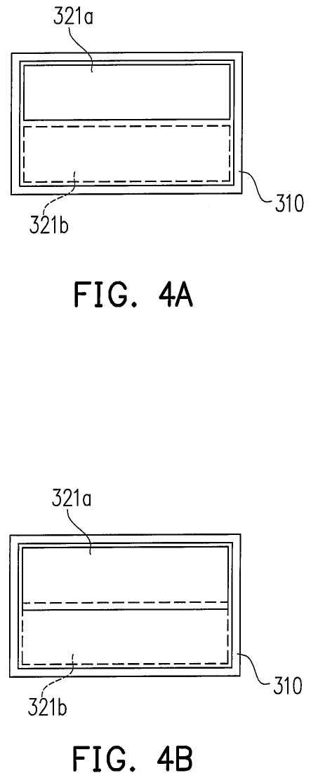

Referring to FIGS. 3 and 4A, in the illumination system 300 described above, the sections of the light beam 321a provided by the light source module 320a and the light beam 321b provided by the light source module 320b are not overlapped at the light incident end 312 of the light integration rod 310. In another embodiment, the sections of the light beam 321a provided by the light source module 320a and the light beam 321b provided by the light source module 320b are partially overlapped at the light incident end 312 of the light integration rod 310 (as shown in FIG. 4B).

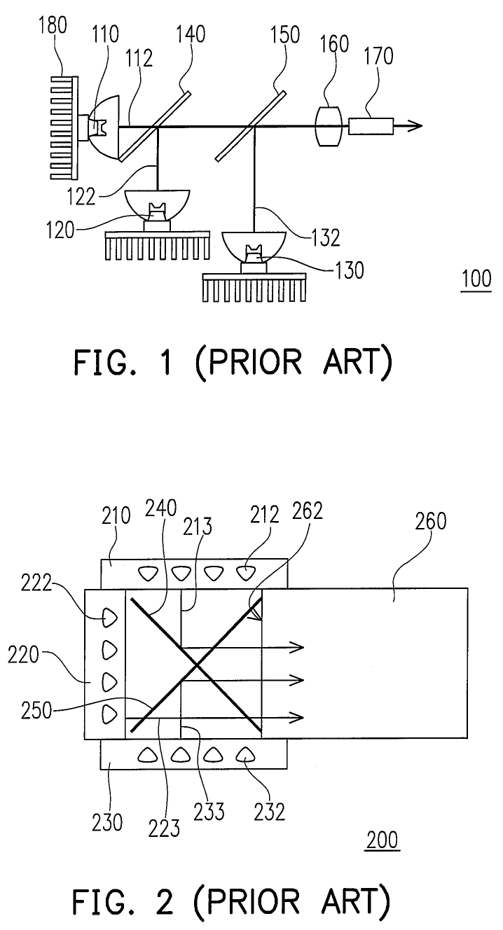

In the embodiment, as the illumination beam 302 provided by the illumination system 300 is converging the light beams 321a, 321b provided by the light source modules 320a, 320b, the defect of insufficient brightness of the illumination beam existing in the conventional illumination system 100 (as shown in FIG. 1) is eliminated. Moreover, compared with the conventional illumination system 200 (as shown in FIG. 2), as the light source modules 320a, 320b of the illumination system 300 of the embodiment are scattered, and light sources 323, 324, 325 of the light source modules 320a, 320b are also arranged dispersedly, each of the light source module is easy to dissipate heat. In other words, expensive heat sinks with complicated structures are not required in the illumination system 300 of this embodiment, thus saving the cost of heat sinks. Furthermore, as the light beams 321a, 321b incident to the light integration rod 310 are both converging light beams, the light use efficiency of the illumination beam 302 provided by the illumination system 300 is better.

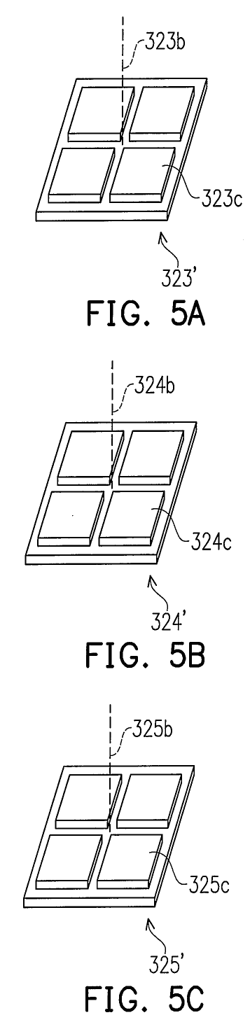

Each of the first color light source, the second color light source, and the third color light source of the light source modules 320a, 320b of the present invention is a single LED chip, and also comprises a plurality of LED chips, so as to enhance the brightness of the illumination beam 302. In FIGS. 5A to 5C, the first color light source 323′ comprises four first color LED chips 323c, the second color light source 324′ comprises four second color LED chips 324c, and the third color light source 325′ comprises four third color LED chips 325c. Moreover, the optical axis 323b of the first color light source 323′ is the central axis of the light beam emitted by the first color LEDs 323c, the optical axis 324b of the second color light source 324′ is the central axis of the light beam emitted by the second color LEDs 324c, and the optical axis 325b of the third color light source 325′ is the central axis of the light beam emitted by the third color LEDs 325c.

In order to further enhance the brightness of the illumination beam provided by the illumination system, in the illumination system of the present invention, the number of the light source modules is more than two, which is illustrated with another embodiment with reference to the accompanied drawings.

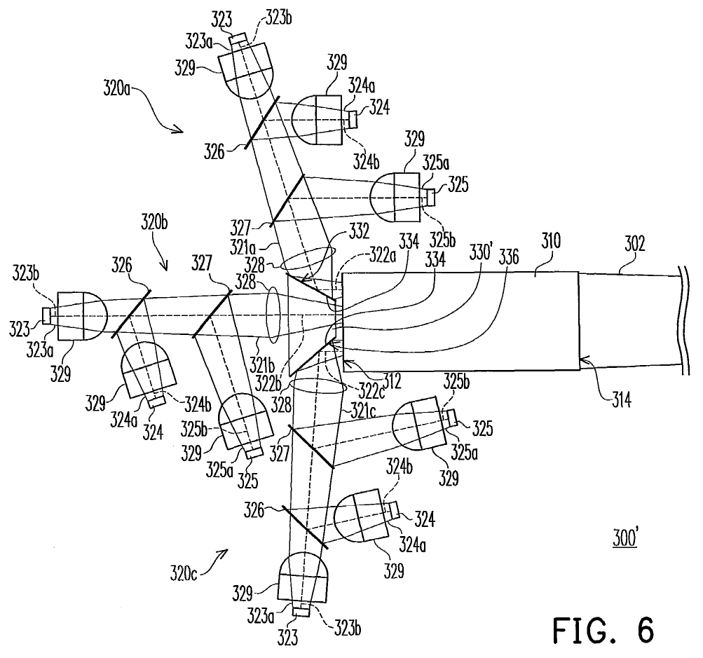

Referring to FIG. 6, the illumination system 300′ of this embodiment is similar to the illumination system 300 as shown in FIG. 3, while the difference lies in that the illumination system 300′ further comprises another light source module 320c in addition to the light source modules 320a and 320b, so as to enhance the brightness of the illumination beam 302. The constitution of the light source module 320c is similar to that of the light source modules 320a, 320b, and the details are not described herein again. In addition, the light guide element disposed in front of the light incident end 312 of the light integration rod 310 and among the light source modules 320a, 320b, 320c is a prism 330′ with two reflecting surfaces 332, 336, wherein the reflecting surface 332 is suitable for reflecting the light beam 321a provided by the light source module 320a to the light integration rod 310, and the reflecting surface 336 is suitable for reflecting the light beam 321c provided by the light source module 320c to the light integration rod 310, and the optical axes 322a, 322c of the light beams 321a, 321c after being reflected by the reflecting surfaces 332, 336 are parallel to the optical axis 322b of the light beam 321b. The reflecting surfaces 332, 336 of the prism 330′ are, for example, the surface of the coating layer 334 disposed on the prism 330′.

In this embodiment, the prism 330′ is also replaced by two reflecting mirrors (not shown), and the positions of the two reflecting mirrors correspond to the positions of the reflecting surfaces 332, 336 of the prism 330′. Moreover, though the first color light source 323, the second color light source 324, and the third color light source 325 of the light source modules 320a, 320b, 320c shown in FIG. 6 are an LED chip, the first color light source 323, the second color light source 324, and the third color light source 325 also comprise a plurality of LED chips. Furthermore, the sections of adjacent light beams (i.e., light beams 321a, 321b and light beams 321b, 321c) are not overlapped or are partially overlapped at the light incident end 312 of the light integration rod 310.

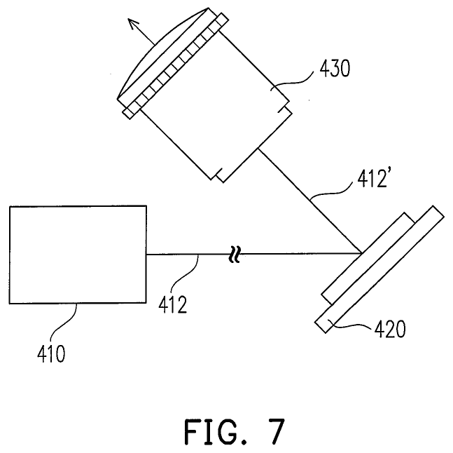

Referring to FIG. 7, the projection apparatus 400 of this embodiment comprises an illumination system 410, a light valve 420, and a projection lens 430. The illumination system 410 is suitable for providing an illumination beam 412, and the light valve 420 is, for example, a digital micro-mirror device (DMD), or a liquid crystal on silicon panel (LCOS panel), which is disposed on the transmission path of the illumination beam 412, so as to convert the illumination beam 412 into an image beam 412′. The projection lens 430 is disposed on the transmission path of the image beam 412′, so as to project the image beam 412′ to display images on the screen. Moreover, the illumination system 410 is, for example, one of the illumination system 300 (as shown in FIG. 3) and the illumination system 300′ (as shown in FIG. 6) described above.

As the illumination system 410 of the projection apparatus 400 is the illumination system 300 or the illumination system 300′ described above, high-brightness images is projected, and the cost for heat sink elements is saved as well.

To sum up, the illumination system and the apparatus of the present invention have at least one of the following advantages.

1. As the illumination beam provided by the illumination system converges the light beams provided by the plurality of light source modules, high brightness is attained.

2. As the light source modules of the illumination system of the present invention are scattered, each of the light source modules is easy to dissipate heat, and expensive heat sinks with complicated structures are not required.

3. In the illumination system of the present invention, the light beams incident to the light integration rod are converging light beams, so the light use efficiency of the illumination beam is better.

4. The illumination system of the projection apparatus of the present invention provides the illumination beam with high brightness, and has preferable heat dissipation effect, so high-brightness images is projected and the cost of heatsink elements is saved as well.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising:
a light integration rod having a light incident end and a light exit end opposite to the light incident end;
a plurality of light source modules disposed adjacent to the light incident end of the light integration rod, and each of the light source modules being suitable for providing a converging light beam; and
a light guide element disposed adjacent to the light incident end of the light integration rod and between the light source modules for guiding each of the light beams to be incident to the light integration rod from the light incident end, the optical axes of the light beams being parallel to each other, a distance existing between any two optical axes of the light beams, the light beams combined inside the light integration rod and emitted from the light exit end to provide an illumination beam.

2. The illumination system as claimed in claim 1, wherein the sections of two adjacent light beams are not overlapped or are partially overlapped at the light incident end.

3. The illumination system as claimed in claim 1, wherein each of the light source modules comprises:
a first color light source suitable for providing a first color light beam;
a second color light source suitable for providing a second color light beam;
a third color light source suitable for providing a third color light beam;
a first dichroic element disposed between the first color light source and the second color light source, wherein the first dichroic element is suitable for allowing the first color light beam to penetrate and reflecting the second color light beam, and the optical axis of the first color light beam after penetrating the first dichroic element is the same as the optical axis of the second color light beam after being reflected by the first dichroic element;
a second dichroic element disposed between the third color light source and the first dichroic element, wherein the second dichroic element is suitable for allowing the first color light beam and the second color light beam to penetrate and reflecting the third color light beam, and the optical axes of the first color light beam and the second color light beam after penetrating the second dichroic element are the same as the optical axis of the third color light beam after being reflected by the second dichroic element; and
a condensing element disposed on the transmission paths of the first color light beam, the second color light beam, and the third color light beam.

4. The illumination system as claimed in claim 3, wherein the first color light source, the second color light source, and the third color light source of each of the light source modules are respectively one of a red light source, a blue light source, and a green light source.

5. The illumination system as claimed in claim 3, wherein each of the first color light source, the second color light source, and the third color light source comprises at least an LED chip.

6. The illumination system as claimed in claim 5, wherein each of the light source modules further comprises a plurality of lenses disposed in front of light exit ends of each of the first color light source, the second color light source, and the third color light source.

7. The illumination system as claimed in claim 3, wherein the first dichroic element and the second dichroic element are dichroic mirrors.

8. The illumination system as claimed in claim 1, wherein the light guide element comprises at least a reflecting mirror, and a part of the light beams is incident to the light integration rod after being reflected by the reflecting mirror.

9. The illumination system as claimed in claim 1, wherein the light guide element comprises at least a prism, the prism has at least a reflecting surface, and a part of the light beams is incident to the light integration rod after being reflected by the reflecting surface of the prism, and the other part of the light beams is incident to the light integration rod after penetrating the prism.

10. The illumination system as claimed in claim 9, wherein the reflecting surface of the prism is a surface of a coating layer disposed on the prism.

11. A projection apparatus, comprising:
an illumination system, including:
a light integration rod having a light incident end and a light exit end opposite to the light incident end;
a plurality of light source modules disposed adjacent to the light incident end of the light integration rod, and each of the light source modules being suitable for providing a converging light beam;
a light guide element disposed adjacent to the light incident end of the light integration rod and between the light source modules for guiding each of the light beams to be incident to the light integration rod from the light incident end, the optical axes of the light beams being parallel to each other, a distance existing between any two optical axes of the light beams, and the light beams being combined inside the light integration rod and emitted from the light exit end to provide an illumination beam;
a light valve disposed on the transmission path of the illumination beam, the light valve being suitable for converting the illumination beam into an image beam; and
a projection lens disposed on the transmission path of the image beam.

12. The projection apparatus as claim in claim 11, wherein the sections of two adjacent light beams are not overlapped or are partially overlapped at the light incident end.

13. The projection apparatus as claimed in claim 11, wherein each of the light source modules comprises:
a first color light source suitable for providing a first color light beam;
a second color light source suitable for providing a second color light beam;
a third color light source suitable for providing a third color light beam;
a first dichroic element disposed between the first color light source and the second color light source, wherein the first light dichroic is suitable for allowing the first color light beam to penetrate and reflecting the second color light beam, and the optical axis of the first color light beam after penetrating the first dichroic element is the same as the optical axis of the second color light beam after being reflected by the first dichroic element;
a second dichroic element disposed between the third color light source and the first dichroic element, wherein the second dichroic element is suitable for allowing the first color light beam and the second color light beam to penetrate and reflecting the third color light beam, and the optical axes of the first color light beam and the second color light beam after penetrating the second dichroic element are the same as the optical axis of the third color light beam after being reflected by the second dichroic element; and
a condensing element disposed on the transmission paths of the first color light beam, the second color light beam, and the third color light beam.

14. The projection apparatus as claimed in claim 13, wherein the first color light source, the second color light source, and the third color light source of each of the light source modules are respectively one of a red light source, a blue light source, and a green light source.

15. The projection apparatus as claimed in claim 13, wherein each of the first color light source, the second color light source, and the third color light source comprises at least an LED chip.

16. The projection apparatus as claimed in claim 15, wherein each of the light source module further comprises a plurality of lenses disposed in front of the light exit ends of each of the first color light source, the second color light source, and the third color light source.

17. The projection apparatus as claimed in claim 13, wherein the first dichroic element and the second dichroic element are dichroic mirrors.

18. The projection apparatus as claimed in claim 11, wherein the light guide element comprises at least a reflecting mirror, and a part of the light beams is incident to the light integration rod after being reflected by the reflecting mirror.

19. The projection apparatus as claimed in claim 11, wherein the light guide element comprises at least a prism, the prism has at least a reflecting surface, and a part of the light beams is incident to the light integration rod after being reflected by the reflecting surface of the prism, while the other part of light beams is incident to the light integration rod after penetrating the prism.

20. The projection apparatus as claimed in claim 19, wherein the reflecting surface of the prism is a surface of a coating layer disposed on the prism.
